(19) United States
(12) Patent Application Publication
(10) Pub. No.: US 2026/0035493 A1
(43) Pub. Date: Feb. 5, 2026

(54) AMINE CONTAINING COPOLYMERS VIA RADICAL POLYMERIZATION AND METHODS OF USE THEREOF

(71) Applicant: Infineum International Limited, Linden, NJ (US)

(72) Inventors: Evan Haidasz, Hoboken, NJ (US); Michael Collins, Oxfordshire (GB); Nigel Male, Wiltshire (GB); Daniel Phillips, Warwickshire (GB)

(73) Assignee: Infineum International Limited, Linden, NJ (US)

(21) Appl. No.: 19/284,957

(22) Filed: Jul. 30, 2025

Related U.S. Application Data
(60) Provisional application No. 63/678,199, filed on Aug. 1, 2024.

(51) Int. Cl. C08F 22/38

(52) U.S. Cl. CPC C08F 22/38

(57) ABSTRACT

Disclosed herein are amine containing copolymer compositions based on free radical and controlled radical polymerization of monomer compositions including an amine-derivatized alpha-methyl styrene (ADAMS) monomer according to structure (I):

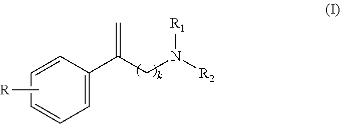

with k, R, R₁, and R₂ defined herein with one or more monomers selected from the group consisting of optionally substituted acrylates, methacrylates, acrylamides, methacrylamides, acrylonitriles, methacrylonitriles, vinyl ethers, N-vinyl amides, or combinations thereof. Further disclosed herein are methods of making and methods for using such copolymer compositions.

### CROSS-REFERENCE TO RELATED APPLICATION

This U.S. Non-provisional application claims priority to U.S. Provisional Application Ser. No. 63/678,199 filed on Aug. 1, 2024, the contents of which are herein incorporated by reference in their entirety.

### FIELD

This disclosure relates to polymer compositions and methods of using such compositions, which may be derived from monomer compositions containing aromatic and/or conjugated (non-aromatic) structures each containing at least one aminic nitrogen. In particular, such functional monomers may be polymerized via radical polymerization to form the functional polymers disclosed herein.

### BACKGROUND

There are myriad references disclosing nitrogen-containing (amine) groups pendant to the phenyl ring in styrenic monomers/polymers/copolymers. However, monomers and polymers bearing such pendant groups can be chemically difficult to synthesize reliably/repetitively. Even when such synthesis can be accomplished, there can be issues with propagation within the polymerization reactions containing such amine-functionalized styrenic monomers, whether alone or as copolymer with other monomers.

Thus, frequently the amine group can be added to a smattering of monomer repeat units using post-polymerization chemical reactions. But post-polymerization chemistry can often come through with different issues, even if it may avoid the propagation issues of amine-functionalized styrenic monomers.

As such, it is desirable to develop an unconventional way to functionalize a styrenic monomer pre-polymerization, particularly one that was neutral to, or perhaps even enhanced, the propagation within the polymerization reaction.

U.S. Pat. Nos. 6,486,272, 9,364,825, 10,202,494, and 10,046,285, disclose polymers made from styrenic monomers bearing nitrogen-containing groups pendant to the phenyl ring, all of which are herein incorporated by reference in their entirety. GB Patent No. 1 381 755 discloses amine-functional monomer compounds, but only with acrylamide functionality. Other examples of potentially relevant publications include, but are not necessarily limited to, U.S. Pat. Nos. 7,790,661, 7,960,320, 8,778,854, and 10,414,999; and PCT Publication No. WO 2021/127183, all of which are herein incorporated by reference in their entirety.

Based on the difficulty of preparing and polymerizing styrenic monomers bearing nitrogen-containing groups pendant to the phenyl ring, Applicant has explored other potential structures for functional monomers which are both simpler to manufacture and also polymerize. These functional monomer compositions containing aromatic and/or conjugated (non-aromatic) structures each containing at least one aminic nitrogen are described in commonly owned related U.S. Provisional Application Ser. No. 63/483,365 filed on Feb. 6, 2023, the contents of which are herein incorporated by reference in their entirety.

U.S. Pat. No. 2,778,826 (“the '826 Schmidle patent”) and a 1955 article by Schmidle and Mansfield, entitled “The Aminomethylation of Olefins. I. The Reaction of Secondary Amines, Formaldehyde, and Olefins,” both disclose various reactions alleging formation of 3-aryl-3-butenyl-1-amines, in which the formaldehyde and secondary amine allegedly formed an iminium, which reacted with the styrenic olefin to form only the terminal (vinylidene) double-bond version of the amine-functional styrenic. The 1955 article also disclosed amine-functionalization of terpenoids such as α- and β-pinene, camphene, and limonene, but not isoprene or similar conjugated non-aromatic compounds.

1983 article by Cohen and Onopchenko, entitled “Competing Hydride Transfer and Ene Reactions in the Aminoalkylation of 1-Alkenes with N,N-Dimethylmethyleniminium Ions. A Literature Correction” (citing, in part, to the '826 Schmidle patent, inter alia), further disclosed a mechanistic study of specifically dimethyliminimum compounds reacting with styrenic and non-styrenic olefins. Notably, at the beginning of the Discussion section, the 1983 article opines that the '826 Schmidle patent (and presumably the 1955 article containing strikingly similar experiments and results thereto) had made mistakes. Nonetheless, with respect to aminomethylation of α-methylstyrene, the 1983 article indicated formation of vinylidene-based product, in tandem with a significant vinylene (not terminal double-bond) content and a quite significant (13%, in the case of the dimethylamino-version) saturated arylalkane-amine content.

The inventive monomers disclosed in U.S. Provisional Application Ser. No. 63/483,365 have, to the best of the Applicant's knowledge, not been previously polymerized.

Based on the foregoing, there is a need to provide functional polymers based on alpha-substituted functional monomers, and in particular functional polymers based on functional monomer compositions containing aromatic and/or conjugated (non-aromatic) structures each containing at least one aminic nitrogen utilizing radical solution polymerization processing techniques.

### SUMMARY

Accordingly, the present disclosure provides inventive copolymer compositions based on free radical and controlled radical polymerization of monomer compositions including an amine-derivatized alpha-methyl styrene (ADAMS) monomer according to structure (I):

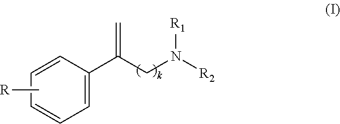

with k, R, R₁, and R₂ defined herein. Further disclosed herein are methods of making and methods for using such polymer compositions.

In one form, disclosed herein is a copolymer comprising:
(a) one or more amine-derivatized alpha-methyl styrene (ADAMS) repeat units according to structure (I):

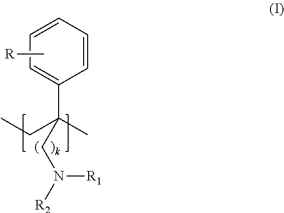

wherein: k is an integer from 1 to 3; R₁ and R₂ are each independently a hydrocarbyl group or a hydrocarbonaceous group having 1 to 4 additional heteroatoms selected from the group consisting of O, N, S, P, Se, and combinations thereof, or wherein R₁ and R₂ are connected to form a moiety containing at least one 5-to 12-membered ring, from 3 to 28 carbons, and optionally 1 to 6 additional heteroatoms selected from the group consisting of O, N, S, P, Se, and combinations thereof; R is hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group, a C₁-C₆ hydrocarbyl group containing 1 to 4 additional heteroatoms selected from the group consisting of O, N, S, P, Se, and combinations thereof;
(b) one or more repeat units selected from the group of structures (II):

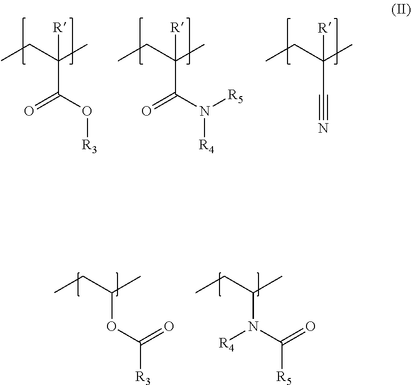

and combinations thereof, wherein: R′ is a hydrogen or methyl group;

R₃, R₄, and R₅ are each independently a hydrogen atom, a hydrocarbyl group having 1 to 30 carbon atoms, or a hydrocarbonaceous group having 1 to 30 carbon atoms and 1 to 6 additional heteroatoms selected from the group consisting of O, N, S, P, Si, and combinations thereof, or wherein R₃ is a hydrocarbyl or hydrocarbonaceous polymer having number-average molecular weight below 10,000 Da and optionally additional heteroatoms selected from the group of O, N, S, P, Se, or a combination thereof, or wherein R₄ and Rs are connected to form a moiety containing at least one 5- to 12-membered ring, from 3 to 30 carbon atoms, and optionally 1 to 6 additional heteroatoms selected from the group consisting of O, N, S, P, Si, or a combination thereof.

In another form, disclosed herein is a copolymer comprising the reaction product of:
(a) one or more monomers according to structure (I)

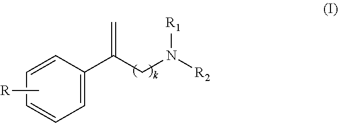

wherein: k is an integer from 1 to 3; R₁ and R₂ are each independently a hydrocarbyl group or a hydrocarbonaceous group having 1 to 4 additional heteroatoms selected from the group consisting of O, N, S, P, Se, and combinations thereof, or wherein R₁ and R₂ are connected to form a moiety containing at least one 5- to 12-membered ring, from 3 to 28 carbons, and optionally 1 to 6 additional heteroatoms selected from the group consisting of O, N, S, P, Se, and combinations thereof; R is hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group, a C₁-C₆ hydrocarbyl group containing 1 to 4 additional heteroatoms selected from the group consisting of O, N, S, P, Se, and combinations thereof;
(b) one or more comonomers selected from the group consisting of optionally substituted acrylates, methacrylates, acrylamides, methacrylamides, acrylonitriles, methacrylonitriles, vinyl ethers, N-vinyl amides, or combinations thereof.

In yet another form, disclosed herein is a method of making a copolymer according to the above paragraphs via radical solution polymerization comprising the steps of: (a) combining the one or more monomers and the one or more comonomers, with or without one or more solvents, under an inert gas atmosphere to form a mixture of monomers and comonomers; (b) optionally adding one or more reaction modifiers comprising chain transfer agents or reversible addition fragmentation chain transfer agents to the mixture of monomers and comonomers; (c) adding one or more radical initiators to the mixture of step (b) to form a mixture of monomers, comonomers, radical initiators and optional reaction modifiers; and (d) heating or cooling the mixture of monomers, comonomers, radical initiators and optional reaction modifiers at a sufficient temperature and for a sufficient time to initiate and propagate radical polymerization to form a copolymer.

In still yet another form, disclosed herein is a method of using a copolymer comprising: providing the copolymer according to the above paragraphs, or an additive mixture including the copolymer according to the above paragraphs, and using the copolymer or the additive mixture including the copolymer in an application selected from the group consisting of an adhesive additive, a lithium-ion battery additive, a plastic additive, a drag reducing agent, a magneto-rheological fluid, an electro-chlorination additive, an industrial coating additive, an asphaltene and wax inhibitor, a refinery anti-foulant, an industrial or household surfactant, an agrochemical additive, a ceramic capacitor or inductor additive, an emulsion explosive additive, an anti-microbial coating, a crude transportation and refining additive, a carbon-capture additive, or a construction material additive.

Other aspects of the present disclosure may become apparent from the Detailed Description and Examples sections hereinbelow.

### DETAILED DESCRIPTION

All numerical values within the detailed description and the claims herein are modified by “about” or “approximately” the indicated value, and take into account experimental error and variations that would be expected by a person having ordinary skill in the art.

### Overview

The present disclosure provides for novel nitrogen containing functional copolymers based on free radical and controlled radical polymerization of monomer compositions including an amine-derivatized alpha-methyl styrene (ADAMS) monomers (also referred to as “ACP monomers”) with a range of different monomers, including, but not limited to, acrylate, methacrylate, acrylonitrile, vinyl ether, and n-vinyl amide monomers. Thus, the monomers of structure (I) below were developed to achieve nitrogen-containing functionality on an alpha-substituted styrenic monomer other than as pendant to the phenyl ring on the styrene unit, which upon polymerization result in one or more repeat units of structure (I) being incorporated into the copolymer.

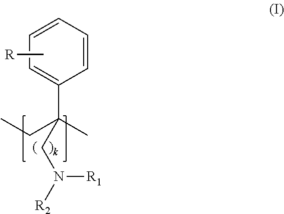

wherein: k is an integer from 1 to 3; R₁ and R₂ are each independently a hydrocarbyl group or a hydrocarbonaceous group having 1 to 4 additional heteroatoms selected from the group consisting of O, N, S, P, Se, and combinations thereof, or wherein R₁ and R₂ are connected to form a moiety containing at least one 5-to 12-membered ring, from 3 to 28 carbons, and optionally 1 to 6 additional heteroatoms selected from the group consisting of O, N, S, P, Se, and combinations thereof; R is hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group, a C₁-C₆ hydrocarbyl group containing 1 to 4 additional heteroatoms selected from the group consisting of O, N, S, P, Se, and combinations thereof.

The comonomers that may be copolymerized with the above ACP monomers according to structure (I) may result in one or more repeat units from the group of structures according to (II) below, which include the following:

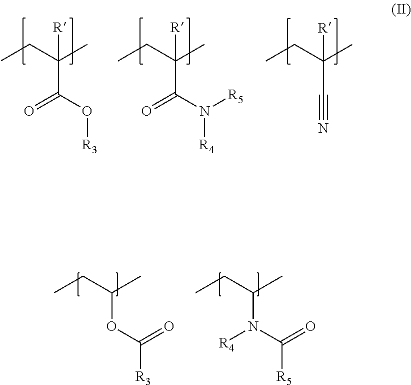

and combinations thereof, wherein: R′ is a hydrogen or methyl group; R₃, R₄, and R₅ are each independently a hydrogen atom, a hydrocarbyl group having 1 to 30 carbon atoms, or a hydrocarbonaceous group having 1 to 30 carbon atoms and 1 to 6 additional heteroatoms selected from the group consisting of O, N, S, P, Si, and combinations thereof, or wherein R₃ is a hydrocarbyl or hydrocarbonaceous polymer having number-average molecular weight below 10,000 Da and optionally additional heteroatoms selected from the group of O, N, S, P, Se, or a combination thereof, or wherein R₄ and Rs are connected to form a moiety containing at least one 5-to 12-membered ring, from 3 to 30 carbon atoms, and optionally 1 to 6 additional heteroatoms selected from the group consisting of O, N, S, P, Si, or a combination thereof.

It should be noted that prior art references often describe functionalized styrenic monomer with nitrogen containing groups pendant to the phenyl ring in general terms (e.g. “dimethylaminoethyl styrene”), which can be similar to the k=2 monomer structure provided below, however, the prior art does not teach or suggest the alpha-substituted functional monomers specifically disclosed herein.

The inventive functional copolymers disclosed herein based on functionalized styrenic monomers including a nitrogen-containing moiety, other than as pendant to the phenyl ring including a nitrogen-containing moiety may be polymerized from addition-polymerizable monomer compositions including amine-derivatized alpha-methyl styrene (ADAMS) monomers according to structure (I) below:

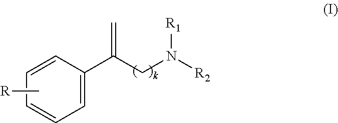

wherein k is an integer from 1 to 3, preferably 2; wherein R₁ and R₂ are each independently a hydrocarbyl group or a hydrocarbonaceous group having 1 to 4 additional heteroatoms, such as O, N, S, P, Se, and combinations thereof, or wherein R₁ and R₂ are connected to form a moiety containing at least one 5- to 12-membered ring, from 3 to 28 carbons, and optionally 1 to 6 additional heteroatoms (such as O, N, S, P, Se, and combinations thereof); wherein R, in structure (I), is hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group (such as a methyl group), a C₁-C₆ hydrocarbyl group containing 1 to 4 additional heteroatoms (such as O, N, S, P, Se, and combinations thereof).

The one or more comonomers for copolymerization with the ADAMS monomers of structure (I) above may include optionally substituted acrylates, methacrylates, acrylamides, methacrylamides, acrylonitriles, methacrylonitriles, vinyl ethers, N-vinyl amides, or combinations thereof.

The inventive functional copolymers disclosed herein based on functionalized styrenic monomers including a nitrogen-containing moiety, other than as pendant to the phenyl ring may be polymerized from the exemplary ADAMS monomers according to structure (I), which include, but are not limited to, 1-diethylamino-3-phenylbut-3-ene, 1-dimethylamino-3-phenylbut-3-ene, 1-di-n-propylamino-3-phenylbut-3-ene, 1-diisopropylamino-3-phenylbut-3-ene, 1-di-2-propenylamino-3-phenylbut-3-ene, 1-di-n-butylamino-3-phenylbut-3-ene, 1-di-sec-butylamino-3-phenylbut-3-ene, 1-diisobutylamino-3-phenylbut-3-ene, 1-di-tert-butylamino-3-phenylbut-3-ene, 1-cyclohexylmethylamino-3-phenylbut-3-ene, 1-dicyclohexylamino-3-phenylbut-3-ene, 1-di-(2-ethylhexyl) amino-3-phenylbut-3-ene, 1-di-(methoxyethyl)amino-3-phenylbut-3-ene, 1-di-(ethoxyethyl)amino-3-phenylbut-3-ene, 1-di-(phenoxyethyl)amino-3-phenylbut-3-ene, 1-di-(methylthioethyl)amino-3-phenylbut-3-ene, 1-di-(ethylthioethyl)amino-3-phenylbut-3-ene, 1-benzylmethylamino-3-phenylbut-3-ene, 1-dibenzylamino-3-phenylbut-3-ene, 1-benzylphenylamino-3-phenylbut-3-ene, 1-diphenylamino-3-phenylbut-3-ene, 1-dipyridylamino-3-phenylbut-3-ene, 1-phenylmethylamino-3-phenylbut-3-ene, 1-phenylmethoxyethylamino-3-phenylbut-3-ene, 1-benzylmethoxyethylamino-3-phenylbut-3-ene, 1-(N-morpholinyl)-3-phenylbut-3-ene, 1-(N-thiomorpholinyl)-3-phenylbut-3-ene, 1-(N-piperidinyl)-3-phenylbut-3-ene, 1-(N-piperazinyl)-3-phenylbut-3-ene, 1-(N-diazepanyl)-3-phenylbut-3-ene, 1-(N-pyrrolidinyl)-3-phenylbut-3-ene, 1-(N-pyrrolyl)-3-phenylbut-3-ene, 1-(1,2,3,4-tetrahydro-1-quinolinyl)-3-phenylbut-3-ene, 1-(1,2,3,4-tetrahydro-2-isoquinolinyl)-3-phenylbut-3-ene, 1-(N-indolinyl)-3-phenylbut-3-ene, 1-(N-indolyl)-3-phenylbut-3-ene, 1-(N-carbazolyl)-3-phenylbut-3-ene, 1-(N-phenothiazinyl)-3-phenylbut-3-ene, 1-(N-phenothiazinyl-S-oxide)-3-phenylbut-3-ene, 1-(N-phenothiazinyl-S,S-dioxide)-3-phenylbut-3-ene, 1-(N-phenoxazinyl)-3-phenylbut-3-ene, 1-(4-methyl-1-piperazinyl)-3-phenylbut-3-ene, 1-(5-methyl-2,5-diazabicyclo[2.2.1]heptan-2-yl)-3-phenylbut-3-ene, 1-(5-methyl-2,5-diazabicyclo[2.2.2]octan-2-yl)-3-phenylbut-3-ene, 1-(4-cyclopentyl-1-piperazinyl)-3-phenylbut-3-ene, 1-(4-cyclopentadienyl-1-piperazinyl)-3-phenylbut-3-ene, 1-(4-phenyl-1-piperazinyl)-3-phenylbut-3-ene, 1-(4-(thiazolyl)-1-piperazinyl)-3-phenylbut-3-ene, 1-(4-(thiadiazolyl)-1-piperazinyl)-3-phenylbut-3-ene, 1-(4-(triazolyl)-1-piperazinyl)-3-phenylbut-3-ene, 1-(4-(1,2,3-benzotriazolyl)-1-piperazinyl)-3-phenylbut-3-ene, 1-(N′-methyl-N-diazepanyl)-3-phenylbut-3-ene, N,N′-bis(3-phenylbut-3-enyl)diazepane, N,N′-bis(3-phenylbut-3-enyl) piperazine, N,N′-bis(3-phenylbut-3-enyl)dihydrophenazine, N,N′-bis(3-phenylbut-3-enyl)dihydrobenzoindazole, N,N′-bis(3-phenylbut-3-enyl)dihydropermidine, N,N′-bis(3-phenylbut-3-enyl)octahydropyridoquinoline, N,N′-bis(3-phenylbut-3-enyl)octahydropyridoisoquinoline, N,N′-bis(3-phenylbut-3-enyl)hexahydropyrroloquinoline, N,N′-bis(3-phenylbut-3-enyl)hexahydropyrroloisoquinoline, N,N′-bis(3-phenylbut-3-enyl)hexahydropyrroloisoindole, N,N′-bis(3-phenylbut-3-enyl)diazabicyclo[2.2.1]heptane, N,N′-bis(3-phenylbut-3-enyl)diazabicyclo[2.2.2]octane, 1,3-bis(1-(3-phenylbut-3-enyl)piperidin-4-yl) propane, bis(1-dimethylamino-3-phenylbut-3-enyl)benzene, bis(1-benzylmethylamino-3-phenylbut-3-enyl)benzene, bis(1-(N-morpholinyl)-3-phenylbut-3-enyl)benzene, bis(1-(N-thiomorpholinyl)-3-phenylbut-3-enyl)benzene, bis(1-(di-methoxyethyl)amino-3-phenylbut-3-enyl)benzene, bis(1-(N-piperidinyl)-3-phenylbut-3-enyl)benzene, bis(1-(N-pyrrolidinyl)-3-phenylbut-3-enyl)benzene, bis(1-(4-methyl-1-piperazinyl))-3-phenylbut-3-enyl)benzene, and combinations thereof.

The inventive functional copolymers disclosed herein based on functionalized styrenic monomers including a nitrogen-containing moiety, other than as pendant to the phenyl ring may be polymerized from the exemplary comonomers according to structure (II), which include, methyl acrylate, ethyl acrylate, propyl acrylate, n-butyl acrylate, s-butyl acrylate, t-butyl acrylate, n-pentyl acrylate, cyclopentyl acrylate, n-hexyl acrylate, cyclohexyl acrylate, phenyl acrylate, benzyl acrylate, n-octyl acrylate, 2-ethylhexyl acrylate, decyl acrylate, lauryl acrylate, stearyl acrylate, 2-methoxyethyl acrylate, 2-ethoxyethyl acrylate, 2-phenoxyethyl acrylate, 2-benzyloxyethyl acrylate, 2-(naphthalen-1-yloxy)ethyl acrylate, 2-(naphthalen-2-yloxy)ethyl acrylate, 2-dimethylaminoethyl acrylate, 2-diethylaminoethyl acrylate, 2-(piperidin-1-yloxy)ethyl acrylate, 2-(morpholin-1-yloxy)ethyl acrylate, methyl methacrylate, ethyl methacrylate, propyl methacrylate, n-butyl methacrylate, s-butyl methacrylate, t-butyl methacrylate, n-pentyl methacrylate, cyclopentyl methacrylate, n-hexyl methacrylate, cyclohexyl methacrylate, phenyl methacrylate, benzyl methacrylate, n-octyl methacrylate, 2-ethylhexyl methacrylate, decyl methacrylate, lauryl methacrylate, stearyl methacrylate, 2-methoxyethyl methacrylate, 2-ethoxyethyl methacrylate, 2-phenoxyethyl methacrylate, 2-benzyloxyethyl methacrylate, 2-(naphthalen-1-yloxy)ethyl methacrylate, 2-(naphthalen-2-yloxy)ethyl methacrylate, 2-dimethylaminoethyl methacrylate, 2-diethylaminoethyl methacrylate, 2-(piperidin-1-yloxy)ethyl methacrylate, 2-(morpholin-1-yloxy)ethyl methacrylate, vinyl acetate, vinyl propanoate, vinyl butyrate, vinyl benzoate, N-vinyl formamide, N-vinyl acetamide, N-vinyl propionamide, N-vinyl butyramide, N-vinyl benzamide, N-vinyl pyrrolidine-2-one, N-vinyl piperidin-2-one, acrylonitrile, methacrylonitrile, or combinations thereof.

The inventive functional copolymers disclosed herein based on functionalized styrenic monomers including a nitrogen-containing moiety, other than as pendant to the phenyl ring may be polymerized from the exemplary comonomers according to structure (II), wherein the optionally substituted acrylates, methacrylates, acrylamides, or methacrylamides comprise a polymer unit further comprising polyethylene, polypropylene, polyisobutylene, polybutadiene, polyisoprene, polyfarnesene, polystyrene, polyethylene glycol, polypropylene glycol, or combinations thereof.

In some embodiments, the inventive functional polymers disclosed herein based on the functionalized styrenic monomers including a nitrogen-containing moiety, other than as pendant to the phenyl ring may be polymerized from the exemplary ADAMS monomers according to structure (I), may exhibit a k value of exactly 2.

For clarity, and as used herein, the inventive functional copolymers disclosed herein based on the functionalized styrenic monomers including a nitrogen-containing moiety, other than as pendant to the phenyl ring may be polymerized from the exemplary ADAMS monomers of structure (I) having a vinylidene bond, such as originating from the olefinic double-bond in alpha-methylstyrene, which can be reflected in -3-enc/-3-enyl language of the IUPAC nomenclature, for example.

The inventive functional copolymers disclosed herein based on functionalized styrenic monomers including a nitrogen-containing moiety, other than as pendant to the phenyl ring, may be preferentially polymerized via radical polymerization processes, including free radical and controlled radical polymerization of the monomer and comonomer compositions disclosed above. However, additionally or alternatively, the inventive functional polymers disclosed herein based on functionalized styrenic monomers including a nitrogen-containing moiety, other than as pendant to the phenyl ring may optionally utilize initiators and/or co-initiators that are, or may be, used in (free) radical polymerization reactions. Non-limiting examples may include, but are not necessarily limited to, azibisisobutyronitrile (AIBN), di-tert-butyl peroxide, and the like, and combinations, reaction products, and/or degradation products thereof.

Provided herein are inventive radically polymerized copolymers derived from functionalized styrenic monomers including a nitrogen-containing moiety, other than as pendant to the phenyl ring. More particularly, the functionalized styrenic monomers including a nitrogen-containing moiety, other than as pendant to the phenyl ring have the general structure:

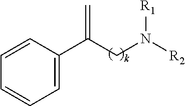

wherein R₁ and R₂ are each independently a hydrocarbyl group or a hydrocarbonaceous group having 1 to 4 additional heteroatoms, such as O, N, S, P, Se, and combinations thereof, or wherein R₁ and R₂ are connected to form a moiety containing at least one 5- to 12-membered ring, from 3 to 28 carbons, and optionally 1 to 6 additional heteroatoms (such as O, N, S, P, Se, and combinations thereof). Monomers with k=2 are preferable due to ease of monomer synthesis and favorable reactivity in the polymerization. Alternatively, monomers with k≥3 may be used, but are more complex to prepare and are less commercially feasible. Alternatively, monomers with k=1 may be used, but are difficult to polymerize via radical polymerization.

The functionalized styrenic monomers including a nitrogen-containing moiety, other than as pendant to the phenyl ring, may be co-polymerized with substituted acrylates, methacrylates, acrylamides, methacrylamides, acrylonitriles, methacrylonitriles, vinyl ethers, N-vinyl amides, or combinations thereof.

In some embodiments one or more polyfunctional comonomers according to structure (III) are included in the polymerization in an amount such that the copolymer forms a crosslinked architecture.

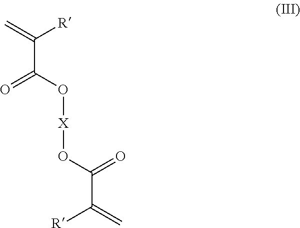

wherein: R′ is a hydrogen or methyl; X is a hydrocarbyl group or a hydrocarbonaceous group having 1 to 20 additional heteroatoms selected from the group consisting of O, N, S, P, Se, and combinations thereof, or wherein X is a hydrocarbyl or hydrocarbonaceous polymer having number-average molecular weight below 10,000 Da and optionally additional heteroatoms selected from the group of O, N, S, P, Se, or a combination thereof.

The inventive functional copolymers disclosed herein based on functionalized styrenic monomers including a nitrogen-containing moiety, other than as pendant to the phenyl ring, and including a polyfunctional comonomer, may be polymerized from the exemplary polyfunctional comonomers according to structure (III), which include ethan-1,2-diyl diacrylate, propan-1,3-diyl diacrylate, butan-1,4-diyl diacrylate, hexan-1,6-diyl diacrylate, octan-1,0-diyl diacrylate, oxybis(ethane-2,1-diyl)diacrylate, (ethane-1,2-diylbis(oxy))bis(ethane-2,1-diyl)diacrylate, ethan-1,2-diyl dimethacrylate, propan-1,3-diyl dimethacrylate, butan-1,4-diyl dimethacrylate, hexan-1,6-diyl dimethacrylate, octan-1,0-diyl dimethacrylate, oxybis(ethane-2,1-diyl) dimethacrylate, (ethane-1,2-diylbis(oxy))bis(ethane-2,1-diyl)dimethacrylate, or combinations thereof, or wherein X in the polyfunctional comonomer of structure (III) is a polymer comprising polyethylene, polypropylene, polyisobutylene, polybutadiene, polyisoprene, polyfarnesene, polystyrene, polyethylene glycol, polypropylene glycol, or combinations thereof.

In some embodiments, the inventive functional polymers disclosed herein based on functionalized styrenic monomers including a nitrogen-containing moiety including a crosslinked polymer architecture may have greater than 20%, or greater than 30%, or greater than 40%, or greater than 50%, or greater 60%, or greater than 70%, or greater than 80%, or greater than 90%, or greater than 95%, of the copolymer crosslinked.

In some embodiments, the inventive functional copolymers disclosed herein based on functionalized styrenic monomers including a nitrogen-containing moiety, other than as pendant to the phenyl ring, may have a number average molecular weight, Mn, of greater than 500 Da, or greater than 1000 Da, or greater than 2000 Da, or greater than 5000 Da, or greater than 10,000 Da. Additionally or alternatively, the inventive functional copolymers disclosed herein based on functionalized styrenic monomers including a nitrogen-containing moiety, other than as pendant to the phenyl ring, or based on functionalized conjugated (non-aromatic) monomers including a nitrogen-containing moiety, may have a number average molecular weight, Mn, of less than 5,000,000 Da, or less than 3,000,000 Da, or less than 1,000,000 Da, or less than 500,000 Da, or less than 200,000 Da.

In some embodiments, the inventive functional copolymers disclosed herein based on functionalized styrenic monomers including a nitrogen-containing moiety, other than as pendant to the phenyl ring, may contain greater than 0.01 wt %, or greater than 0.05 wt %, or greater than 0.1 wt %, or greater than 0.5 wt %, or greater than 1.0 wt %, or greater than 5.0 wt %, or greater than 10 wt %, or greater than 15 wt %, or greater than 20 wt % of repeat units according to structure (I).

In some embodiments, the inventive functional copolymers disclosed herein based on functionalized styrenic monomers including a nitrogen-containing moiety, other than as pendant to the phenyl ring, or based on functionalized conjugated (non-aromatic) monomers including a nitrogen-containing moiety, may optionally be further subjected to post-polymerization modification in order to modify their structure.

In some embodiments, the post-polymerization modification is a protonation reaction, wherein one or more amine functional groups within repeat units, are converted to their corresponding ammonium salts by treatment with a protic acid. The protic acid may be any acid which is sufficiently strong to protonate a basic nitrogen atom in the repeat units and thereby form an ammonium salt of the repeat unit with a counterion corresponding to the conjugate base of the protic acid. Non-limiting examples of the protic acid may include hydrochloric acid, hydrobromic acid, hydroiodic acid, various alkyl or aryl sulfonic acids (i.e. methylsulfonic acid, ethylsulfonic acid, propylsulfonic acid, n-butylsulfonic acid, tert-butylsulfonic acid, benzenesulfonic acid, p-toluenesulfonic acid, p-dodecylbenzenesulfonic acid, and the like), sulfuric acid, phosphoric acid, formic acid, acetic acid, butyric acid, benzoic acid, triflic acid, nitric acid, or a combination thereof, which would yield ammonium salts with respectively chloride, bromide, iodide, alkyl or aryl sulfonate, sulfate, phosphate, formate, acetate, propionate, butyrate, benzoate, triflate, nitrate counterion, or a combination thereof, counterions.

In some embodiments, the post-polymerization modification is an alkylation reaction, wherein one or more amine functional groups within repeat units are converted to their corresponding ammonium salts by treatment with an alkylating agent. Non-limiting examples of alkylating agents may include various alkyl halides (i.e. bromomethane, iodomethane, bromoethane, iodoethane, bromopropane, iodopropane, benzyl chloride, benzyl bromide, benzyl iodide, and the like), various alkyl sulfonates (i.e. methyl tosylate, ethyl tosylate, propyl tosylate, benzyl tosylate, methyl methanesulfonate, ethyl methanesulfonate, propyl methanesulfonate, benzyl methanesulfonate, and the like), various alkly triflates (i.e. methyl triflate, ethyl triflate, propyl triflate, and the like), or a combination thereof, which would yield ammonium salts with counterions corresponding to the displaced leaving groups of the alkylating agent.

### Embodiments Directed to ADAMS Copolymers

In one form of the invention disclosed herein, copolymer compositions based on amine-derivatized alpha-methyl styrene (ADAMS) monomer (referred to also as ADAMS copolymers) are polymerized via free radical and controlled radical polymerization. In particular, in one form the ADAMS copolymers include the following: (a) one or more amine-derivatized alpha-methyl styrene (ADAMS) repeat units according to structure (I):

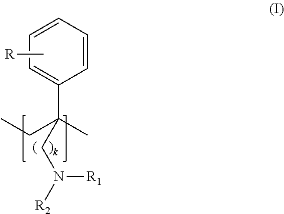

wherein: k is an integer from 1 to 3; R₁ and R₂ are each independently a hydrocarbyl group or a hydrocarbonaceous group having 1 to 4 additional heteroatoms selected from the group consisting of O, N, S, P, Se, and combinations thereof, or wherein R₁ and R₂ are connected to form a moiety containing at least one 5- to 12-membered ring, from 3 to 28 carbons, and optionally 1 to 6 additional heteroatoms selected from the group consisting of O, N, S, P, Se, and combinations thereof; R is hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group, a C₁-C₆ hydrocarbyl group containing 1 to 4 additional heteroatoms selected from the group consisting of O, N, S, P, Se, and combinations thereof; and
(b) one or more repeat units selected from the group of structures (II):

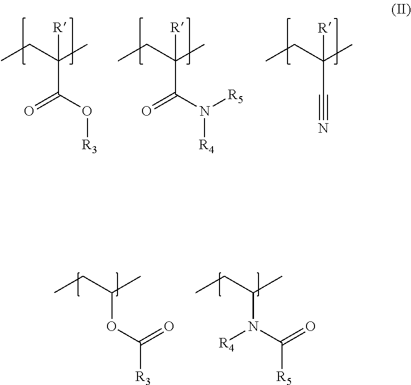

and combinations thereof, wherein: R′ is a hydrogen or methyl group; R₃, R₄, and R₅ are each independently a hydrogen atom, a hydrocarbyl group having 1 to 30 carbon atoms, or a hydrocarbonaceous group having 1 to 30 carbon atoms and 1 to 6 additional heteroatoms selected from the group consisting of O, N, S, P, Si, and combinations thereof, or wherein R₃ is a hydrocarbyl or hydrocarbonaceous polymer having number-average molecular weight below 10,000 Da and optionally additional heteroatoms selected from the group of O, N, S, P, Se, or a combination thereof, or wherein R₄ and Rs are connected to form a moiety containing at least one 5-to 12-membered ring, from 3 to 30 carbon atoms, and optionally 1 to 6 additional heteroatoms selected from the group consisting of O, N, S, P, Si, or a combination thereof.

In an advantageous form, k=2 for the ADAMS copolymers described above. The above copolymers may include one or more ADAMS repeat units according to structure (I), which comprise the reacted form of the following: 1-dimethylamino-3-phenylbut-3-ene, 1-diethylamino-3-phenylbut-3-ene, 1-di-n-propylamino-3-phenylbut-3-ene, 1-diisopropylamino-3-phenylbut-3-ene, 1-di-2-propenylamino-3-phenylbut-3-ene, 1-di-n-butylamino-3-phenylbut-3-ene, 1-di-sec-butylamino-3-phenylbut-3-ene, 1-diisobutylamino-3-phenylbut-3-ene, 1-di-tert-butylamino-3-phenylbut-3-ene, 1-cyclohexylmethylamino-3-phenylbut-3-ene, 1-dicyclohexylamino-3-phenylbut-3-ene, 1-di-(2-ethylhexyl)amino-3-phenylbut-3-ene, 1-di-(methoxyethyl)amino-3-phenylbut-3-ene, 1-di-(ethoxyethyl)amino-3-phenylbut-3-ene, 1-di-(phenoxyethyl)amino-3-phenylbut-3-ene, 1-di-(methylthioethyl)amino-3-phenylbut-3-ene, 1-di-(ethylthioethyl)amino-3-phenylbut-3-ene, 1-benzylmethylamino-3-phenylbut-3-ene, 1-dibenzylamino-3-phenylbut-3-ene, 1-benzylphenylamino-3-phenylbut-3-ene, 1-diphenylamino-3-phenylbut-3-ene, 1-dipyridylamino-3-phenylbut-3-ene, 1-phenylmethylamino-3-phenylbut-3-ene, 1-phenylmethoxyethylamino-3-phenylbut-3-ene, 1-benzylmethoxyethylamino-3-phenylbut-3-ene, 1-(N-morpholinyl)-3-phenylbut-3-ene, 1-(N-thiomorpholinyl)-3-phenylbut-3-ene, 1-(N-piperidinyl)-3-phenylbut-3-ene, 1-(N-piperazinyl)-3-1-(N-diazepanyl)-3-phenylbut-3-ene, 1-(N-pyrrolidinyl)-3-phenylbut-3-ene, 1-(N-pyrrolyl)-3-phenylbut-3-ene, 1-(1,2,3,4-tetrahydro-1-quinolinyl)-3-phenylbut-3-ene, 1-(1,2,3,4-tetrahydro-2-isoquinolinyl)-3-phenylbut-3-ene, 1-(N-indolinyl)-3-phenylbut-3-ene, 1-(N-indolyl)-3-phenylbut-3-ene, 1-(N-carbazolyl)-3-phenylbut-3-ene, 1-(N-phenothiazinyl)-3-phenylbut-3-ene, 1-(N-phenothiazinyl-S-oxide)-3-phenylbut-3-ene, 1-(N-phenothiazinyl-S,S-dioxide)-3-phenylbut-3-ene, 1-(N-phenoxazinyl)-3-phenylbut-3-ene, 1-(4-methyl-1-piperazinyl)-3-phenylbut-3-ene, 1-(5-methyl-2,5-diazabicyclo[2.2.1]heptan-2-yl)-3-phenylbut-3-ene, 1-(5-methyl-2,5-diazabicyclo[2.2.2]octan-2-yl)-3-phenylbut-3-ene, 1-(4-cyclopentyl-1-piperazinyl)-3-phenylbut-3-ene, 1-(4-cyclopentadienyl-1-piperazinyl)-3-phenylbut-3-ene, 1-(4-phenyl-1-piperazinyl)-3-phenylbut-3-ene, 1-(4-(thiazolyl)-1-piperazinyl)-3-phenylbut-3-ene, 1-(4-(thiadiazolyl)-1-piperazinyl)-3-phenylbut-3-ene, 1-(4-(triazolyl)-1-piperazinyl)-3-phenylbut-3-ene, 1-(4-(1,2,3-benzotriazolyl)-1-piperazinyl)-3-phenylbut-3-ene, 1-(N′-methyl-N-diazepanyl)-3-phenylbut-3-ene,

N,N′-bis(3-phenylbut-3-enyl)diazepane, N,N′-bis(3-phenylbut-3-enyl)piperazine, N,N′-bis(3-phenylbut-3-enyl)dihydrophenazine, N,N′-bis(3-phenylbut-3-enyl)dihydrobenzoindazole, N,N′-bis(3-phenylbut-3-enyl)dihydropermidine, N,N′-bis(3-phenylbut-3-enyl)octahydropyridoquinoline, N,N′-bis(3-phenylbut-3-enyl)octahydropyridoisoquinoline, N,N′-bis(3-phenylbut-3-enyl)hexahydropyrroloquinoline, N,N′-bis(3-phenylbut-3-enyl) hexahydropyrroloisoquinoline, N,N′-bis(3-phenylbut-3-enyl)hexahydropyrroloisoindole, N,N′-bis(3-phenylbut-3-enyl)diazabicyclo[2.2.1]heptane, N,N′-bis(3-phenylbut-3-enyl)diazabicyclo[2.2.2]octane, 1,3-bis(1-(3-phenylbut-3-enyl)piperidin-4-yl) propane, bis(1-dimethylamino-3-phenylbut-3-enyl) benzene, bis(1-benzylmethylamino-3-phenylbut-3-enyl) benzene, bis(1-(N-morpholinyl)-3-phenylbut-3-enyl) benzene, bis(1-(N-thiomorpholinyl)-3-phenylbut-3-enyl)benzene, bis(1-(di-methoxyethyl)amino-3-phenylbut-3-enyl)benzene, bis(1-(N-piperidinyl)-3-phenylbut-3-enyl)benzene, bis(1-(N-pyrrolidinyl)-3-phenylbut-3-enyl)benzene, bis(1-(4-methyl-1-piperazinyl))-3-phenylbut-3-enyl)benzene, or a combination thereof.

The above copolymers may also include one or more repeat units selected from the group of structures (II) including the reacted form of acrylates, methacrylates, acrylamides, methacrylamides, acrylonitriles, methacrylonitriles, vinyl ethers, N-vinyl amides, and combinations thereof. Alternatively, the above copolymers may include or additionally include one or more additional repeat units comprising the reacted form of styrene, alpha-methylstyrene, para-methylstyrene, 2-vinylpyridine, 3-vinylpyridine, 4-vinylpyridine, or a combination thereof.

Alternatively, the above copolymers may further include one or more additional repeat units according to structure (III):

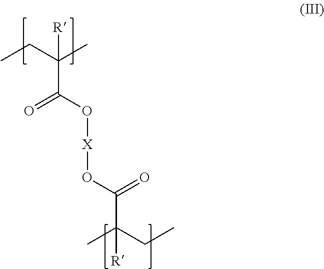

wherein: R′ is a hydrogen or methyl; X is a hydrocarbyl group or a hydrocarbonaceous group having 1 to 20 additional heteroatoms selected from the group consisting of O, N, S, P, Se, and combinations thereof, or wherein X is a hydrocarbyl or hydrocarbonaceous polymer having number-average molecular weight below 10,000 Da and optionally additional heteroatoms selected from the group of O, N, S, P, Se, or a combination thereof.

With regard to the above described copolymers, an amino group in one or more repeat units of structure (I) may be alternatively protonated or alkylated to their corresponding ammonium salt. Protonated or alkylated ammonium salts may, for example, include a chloride, bromide, iodide, alkyl or aryl sulfonate, sulfate, phosphate, formate, acetate, propionate, butyrate, benzoate, triflate, nitrate counterion, or a combination thereof.

In particular, in one form the ADAMS copolymers disclosed herein, include the reaction product of: (a) one or more monomers according to structure (I)

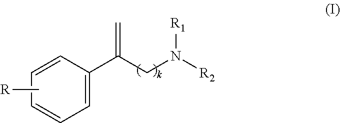

wherein: k is an integer from 1 to 3; R₁ and R₂ are each independently a hydrocarbyl group or a hydrocarbonaceous group having 1 to 4 additional heteroatoms selected from the group consisting of O, N, S, P, Se, and combinations thereof, or wherein R₁ and R₂ are connected to form a moiety containing at least one 5-to 12-membered ring, from 3 to 28 carbons, and optionally 1 to 6 additional heteroatoms selected from the group consisting of O, N, S, P, Se, and combinations thereof; R is hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group, a C₁-C₆ hydrocarbyl group containing 1 to 4 additional heteroatoms selected from the group consisting of O, N, S, P, Se, and combinations thereof; and
(b) one or more comonomers selected from the group consisting of optionally substituted acrylates, methacrylates, acrylamides, methacrylamides, acrylonitriles, methacrylonitriles, vinyl ethers, N-vinyl amides, or combinations thereof.

For this form of the inventive ADAMS copolymers, the one or more monomers according to structure (I) may also comprise the following: 1-dimethylamino-3-phenylbut-3-ene, 1-diethylamino-3-phenylbut-3-ene, 1-di-n-propylamino-3-phenylbut-3-ene, 1-diisopropylamino-3-phenylbut-3-ene, 1-di-2-propenylamino-3-phenylbut-3-ene, 1-di-n-butylamino-3-phenylbut-3-ene, 1-di-sec-butylamino-3-phenylbut-3-ene, 1-diisobutylamino-3-phenylbut-3-ene, 1-di-tert-butylamino-3-phenylbut-3-ene, 1-cyclohexylmethylamino-3-phenylbut-3-ene, 1-dicyclohexylamino-3-phenylbut-3-ene, 1-di-(2-ethylhexyl)amino-3-phenylbut-3-ene, 1-di-(methoxyethyl)amino-3-phenylbut-3-ene, 1-di-(ethoxyethyl)amino-3-phenylbut-3-ene, 1-di-(phenoxyethyl)amino-3-phenylbut-3-ene, 1-di-(methylthioethyl)amino-3-phenylbut-3-ene, 1-di-(ethylthioethyl)amino-3-phenylbut-3-ene, 1-benzylmethylamino-3-phenylbut-3-ene, 1-dibenzylamino-3-phenylbut-3-ene, 1-benzylphenylamino-3-phenylbut-3-ene, 1-diphenylamino-3-phenylbut-3-ene, 1-dipyridylamino-3-phenylbut-3-ene, 1-phenylmethylamino-3-phenylbut-3-ene, 1-phenylmethoxyethylamino-3-phenylbut-3-ene, 1-benzylmethoxyethylamino-3-phenylbut-3-ene, 1-(N-morpholinyl)-3-phenylbut-3-ene, 1-(N-thiomorpholinyl)-3-1-(N-piperidinyl)-3-phenylbut-3-ene, 1-(N-piperazinyl)-3-phenylbut-3-ene, 1-(N-diazepanyl)-3-phenylbut-3-ene, 1-(N-pyrrolidinyl)-3-phenylbut-3-ene, 1-(N-pyrrolyl)-3-phenylbut-3-ene, 1-(1,2,3,4-tetrahydro-1-quinolinyl)-3-phenylbut-3-ene, 1-(1,2,3,4-tetrahydro-2-isoquinolinyl)-3-phenylbut-3-ene, 1-(N-indolinyl)-3-phenylbut-3-ene, 1-(N-indolyl)-3-phenylbut-3-ene, 1-(N-carbazolyl)-3-phenylbut-3-ene, 1-(N-phenothiazinyl)-3-phenylbut-3-ene, 1-(N-phenothiazinyl-S-oxide)-3-phenylbut-3-ene, 1-(N-phenothiazinyl-S,S-dioxide)-3-phenylbut-3-ene, 1-(N-phenoxazinyl)-3-phenylbut-3-ene, 1-(4-methyl-1-piperazinyl)-3-phenylbut-3-ene, 1-(5-methyl-2,5-diazabicyclo[2.2.1]heptan-2-yl)-3-phenylbut-3-ene, 1-(5-methyl-2,5-diazabicyclo[2.2.2]octan-2-yl)-3-phenylbut-3-ene, 1-(4-cyclopentyl-1-piperazinyl)-3-phenylbut-3-ene, 1-(4-cyclopentadienyl-1-piperazinyl)-3-phenylbut-3-ene, 1-(4-phenyl-1-piperazinyl)-3-phenylbut-3-ene, 1-(4-(thiazolyl)-1-piperazinyl)-3-phenylbut-3-ene, 1-(4-(thiadiazolyl)-1-piperazinyl)-3-phenylbut-3-ene, 1-(4-(triazolyl)-1-piperazinyl)-3-phenylbut-3-ene, 1-(4-(1,2,3-benzotriazolyl)-1-piperazinyl)-3-phenylbut-3-ene, 1-(N′-methyl-N-diazepanyl)-3-phenylbut-3-ene, piperazinyl)-3-phenylbut-3-ene, N,N′-bis(3-phenylbut-3-enyl)diazepane, N,N′-bis(3-phenylbut-3-enyl) piperazine, N,N′-bis(3-phenylbut-3-enyl)dihydrophenazine, N,N′-bis(3-phenylbut-3-enyl)dihydrobenzoindazole, N,N′-bis(3-phenylbut-3-enyl)dihydropermidine, N,N′-bis(3-phenylbut-3-enyl)octahydropyridoquinoline, N,N′-bis(3-phenylbut-3-enyl)octahydropyridoisoquinoline, N,N′-bis(3-phenylbut-3-enyl)hexahydropyrroloquinoline, N,N′-bis(3-phenylbut-3-enyl)hexahydropyrroloisoquinoline, N,N′-bis(3-phenylbut-3-enyl)hexahydropyrroloisoindole, N,N′-bis(3-phenylbut-3-enyl)diazabicyclo[2.2.1]heptane, N,N′-bis(3-phenylbut-3-enyl) diazabicyclo[2.2.2]octane, 1,3-bis(1-(3-phenylbut-3-enyl) piperidin-4-yl) propane, bis(1-dimethylamino-3-phenylbut-3-enyl)benzene, bis(1-benzylmethylamino-3-phenylbut-3-enyl) benzene, bis(1-(N-morpholinyl)-3-phenylbut-3-enyl) benzene, bis(1-(N-thiomorpholinyl)-3-phenylbut-3-enyl)benzene, bis(1-(di-methoxyethyl)amino-3-phenylbut-3-enyl)benzene, bis(1-(N-piperidinyl)-3-phenylbut-3-enyl)benzene, bis(1-(N-pyrrolidinyl)-3-phenylbut-3-enyl)benzene, bis(1-(4-methyl-1-piperazinyl))-3-phenylbut-3-enyl)benzene, or a combination thereof.

In still yet another form, the ADAMS copolymers described above may be such that wherein an amino group in one or more repeat units of structure (I) are protonated or alkylated to their corresponding ammonium salt. In such a form, the protonated or alkylated ammonium salt may include a chloride, bromide, iodide, alkyl or aryl sulfonate, sulfate, phosphate, formate, acetate, propionate, butyrate, benzoate, triflate, nitrate counterion, or a combination thereof.

### Methods of Using the ADAMS Copolymers

The novel copolymers based on free radical and controlled radical polymerization of monomer compositions including an amine-derivatized alpha-methyl styrene (ADAMS) monomers (also referred to as “ACP monomers”) may be used for a range of different applications. In particular, the inventive functional copolymers disclosed herein based on functionalized styrenic monomers including a nitrogen-containing moiety, other than as pendant to the phenyl ring, may be polymerized from (a) addition-polymerizable monomer compositions including amine-derivatized alpha-methyl styrene (ADAMS) monomers according to structure (I) below:

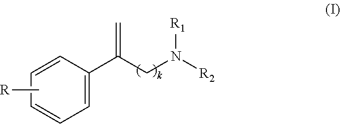

wherein k is an integer from 1 to 3, preferably 2; wherein R₁ and R₂ are each independently a hydrocarbyl group or a hydrocarbonaceous group having 1 to 4 additional heteroatoms, such as O, N, S, P, Se, and combinations thereof, or wherein R₁ and R₂ are connected to form a moiety containing at least one 5-to 12-membered ring, from 3 to 28 carbons, and optionally 1 to 6 additional heteroatoms (such as O, N, S, P, Se, and combinations thereof); wherein R, in structure (I), is hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group (such as a methyl group), a C₁-C₆ hydrocarbyl group containing 1 to 4 additional heteroatoms (such as O, N, S, P, Se, and combinations thereof), and
(b) one or more monomers selected from the group consisting of optionally substituted acrylates, methacrylates, acrylamides, methacrylamides, acrylonitriles, methacrylonitriles, vinyl ethers, N-vinyl amides, or combinations thereof.

In particular, the copolymer compositions based on anionic polymerization of functionalized styrenic monomers including a nitrogen-containing moiety, other than as pendant to the phenyl ring, may be used for variety of applications including, but not limited to, an adhesive additive, a lithium-ion battery additive, a plastic additive, a drag reducing agent, a magneto-rheological fluid, an electro-chlorination additive, an industrial coating additive, an asphaltene and wax inhibitor, a refinery anti-foulant, an industrial or household surfactant, an agrochemical additive, a ceramic capacitor or inductor additive, an emulsion explosive additive, an anti-microbial coating, a crude transportation and refining additive, a carbon-capture additive, or a construction material additive.

### Methods of Making the ADAMS Copolymers

The novel copolymers of functionalized styrenic monomers including a nitrogen-containing moiety, other than as pendant to the phenyl ring, or of functionalized conjugated (non-aromatic) monomers including a nitrogen-containing moiety, may be made by free radical or controlled radical polymerization techniques such as RAFT (Reversible Addition Fragmentation Chain Transfer). Customary free-radical polymerization is explained, inter alia, in Ullmanns's Encyclopedia of Industrial Chemistry, Sixth Edition.

The inventive radical polymerization processes disclosed herein generally comprise at least the following steps:
(a) combining one or more radically polymerizable monomers, optionally with or without solvent, preferably maintained under an inert (typically N2 or Ar) atmosphere;
(b) optionally adding one or more reaction modifiers, such as chain transfer agents (CTAs) or reversible addition fragmentation chain transfer (RAFT) agents;
(c) adding one or more radical initiators;
(d) heating or cooling the polymerization mixture to a sufficient temperature, and for a sufficient time, such that radical initiation and polymerization reactions occur. A sufficient time may be at least 30 minutes, or at least 60 minutes, or at least 90 minutes, or at least 120 minutes, or at least 240 minutes, or at least 360 minutes. A sufficient temperature may be at least 25° C., or at least 35° C., or at least 45° C., or at least 55° C., or at least 65° C., or at least 75° C., or at least 85° C., or at least 95° C., or at least 105° C.

In some embodiments the one or more radical initiators are azo initiators such as 1,1-azobiscyclohexanecarbonitrile, 2,2′-azobis(2-methylpropionitrile), or peroxy compounds such as di-tert-butyl peroxide, methyl ethyl ketone peroxide, acetylacetone peroxide, dilauryl peroxide, tert-butyl peroxy-2-ethylhexanoate, tert-butyl peroctoate, methyl isobutyl ketone peroxide, cyclohexanone peroxide, dibenzoyl peroxide, tert-butyl peroxybenzoate, tert-butylperoxyisopropyl carbonate, 2,5-bis(2-ethylhexanoate, tert-butylperoxy-3,5,5-trimethylhexanoate, dicumyl peroxide, 1,1-bis(tert-butylperoxy) cyclohexane, 1, 1-bis(tert-butylperoxy)-3,3,5-trimethylcycohexane, cumyl hydroperoxide, tert-butyl hydroperoxide, or combinations thereof, as well as mixtures of the aforementioned compounds with other compounds that can, individually or collectively, form free radicals effectively in the mixture.

In some embodiments, the optional one or more solvents include aromatic hydrocarbons such as toluene, xylene; esters such as butyl acetate, ethyl acetate, propyl acetate; ketones such as ethyl methyl ketone, acetone, methyl isobutyl ketone, or cyclohexanone; alcohols such as isopropanol, n-propanol, isobutanol; ethers such a glycol monomethyl ethers, glycol monoethyl ethers, glycol monobutyl ethers; aliphatics such as pentane, hexane, cycloalkanes and substituted cycloalkanes such as cyclohexane, or combinations thereof.

In some embodiments the one or more chain transfer agents (CTA), can be optionally added to the polymerization reaction. Chain transfer agents include mercapto compounds such as t-dodecyl mercaptan, dialkyl sulfides, dialkyl disulfides and/or diaryl sulfides, such as di-n-butyl sulfide, di-n-octyl sulfide, diphenyl sulfide, thiodiglycol, ethylthioethanol, diisopropyl disulfide, di-n-butyl disulfide, di-n-hexyl disulfide, diacetyl disulfide, diethanol disulfide, di-tert-butyl trisulfide and dimethyl sulfoxide, ethyl thioglycolate, 2-ethylhexyl thioglycolate, cysteine, 2-mercaptoethanol, 3-mercaptopropanol, 3-mercaptopropan-1,2-diol, 1,4-mercaptobutanol, mercaptoacetic acid, 3-mercaptopropionic acid, mercaptosuccinic acid, thioglycerol, thioacetic acid, thiourea, n-butyl mercaptan, n-hexyl mercaptan, n-dodecyl mercaptan, dimeric alpha-methylstyrene, (2,4-diphenyl-4-methyl-1-pentene), enol ethers of aliphatic and/or cycloaliphatic aldehydes, terpenes, beta-terpinene, terpinolene, 1,4-cyclohexadiene, 1,4-dihydronaphthalene, 1,4,5,8-tertrahydronapthalene, 2,5-dihydrofuran, 2,5-dimethylfuran and/or 3,6-dihdro-2H-pyran, or combinations thereof.

RAFT polymerization processes are well known in the art and are described, for example, in PCT Publication Nos. WO 98/01478 and WO 2004/083169, which are herein incorporated by reference in their entirety.

The polymerization reaction can be heated or cooled to a sufficient temperature for the one or more radical initiator to generate reactive radicals in the mixture. Depending on the specific radical initiator or combination used, the reaction temperature may be from 0 to 180° C., or from 5 to 160° C., or from 10 to 140° C., or from 20 to 120° C., or from 30 to 100° C., or from 40 to 80° C., or from 50 to 60° C. The reaction temperature may also be changed over the course of the reaction within the above ranges.

The polymerization reaction is run for a sufficient time that at least 20 wt %, or at least 40 wt %, or at least 60 wt %, or at least 80 wt %, or at least 90 wt %, or at least 95 wt %, or at least 98 wt % of the one or more radically polymerizable monomers have polymerized.

The inventive monomers disclosed in U.S. Provisional Application Ser. No. 63/483,365 have, to the best of the Applicant's knowledge, not been previously polymerized.

The invention will now be described by way of non-limiting examples only.

### EXAMPLES

Microwave reactions were conducted using a BIOTAGE INITIATOR+microwave reactor on 2-20 mL scale in appropriately sized microwave reaction vials, part #352016, 351521, and 354833 from BIOTAGE.

Gel permeation chromatography (GPC) samples were prepared by dissolving a ˜50 mg sample of the crude reaction mixture in 5.0 ml stabilized tetrahydrofuran (THF, 99.9%, 250 ppm BHT stabilizer) targeting a final sample concentration between 1.0-5.0 g polymer/ml THF. Samples were filtered through a 0.35 μm PTFE syringe filter, before being analyzed. GPC was run using an AGILENT 1260 INFINITY II system, equipped with an AGILENT 1260 refractive index detector, and three AGILENT PLGEL 10 μm mixed-D chromatography columns maintained at 35° C. by the GPC column heater. Samples were run using a 100 μL injection volume, using stabilized THF (1.0 ml/min, isocratic) as the mobile phase.

GPC data analysis used AGILENT CIRUS GPC/SEC software, version 3.4.2. The GPC was calibrated using polystyrene (PS) test kit standards of known molecular weight and narrow polydispersity index (PDI≤1.1). All polymer Mn, Mw, Mz values are reported vs. PS standard, unless specified otherwise.

To prepare the NMR samples, ˜50 μl of the crude reaction mixture was added to a vial followed by 500 μL of CDCl₃ (THERMOSCI, 426771000). The vial was sealed, mixed thoroughly until the sample had fully dissolved, and then transferred to an NMR tube.

¹H NMR spectra (16 scans) were recorded at 300 MHz with a BRUKER AVANCE™-III NANOBAY NMR spectrometer. Chemical shifts (8) are quoted in parts per million (ppm), referenced to TMS contained in the NMR solvent or, preferably, to the CDCl₃ solvent peak calibrating the solvent peak to 7.26 ppm.

Quantitative NMR measurements were conducted by relative integration of the vinylic C—H peaks for the monomers, corresponding to chemical shifts of ˜5.1 ppm and ˜6.4 ppm for the ADAMS monomer and acrylate comonomer respectively, compared to the benzoate ortho-C—H peaks of the benzyl benzoate internal standard, corresponding to a chemical shift of ˜8.0 ppm.

### Example 1

To a 0.5-2 mL microwave reaction vial, containing a magnetic stir bar, was charged 13.4 mg azobisisobutyronitrile (AIBN, 0.082 mmol, 0.01 eq.), 0.429 g N,N-bis(2-methoxyethyl)-3-phenylbut-3-en-1-amine (1.63 mmol, 0.2 eq.), 1.500 g 2-ethylhexyl acrylate (8.14 mmol, 1.0 eq.), and ˜100 μL benzyl benzoate (internal HNMR standard).

The reaction vial was then capped and the reaction mixture homogenised using a vortex mixer. A ˜50 μL aliquot of the starting reaction mixture was taken for ¹H NMR analysis using a needle+syringe inserted through the septum on the vial cap. The reaction mixture and vial headspace were then degassed with N2 for 15 minutes.

The reaction vial was then mixture heated to 90° C. for 5 hours, using the using a BIOTAGE INITIATOR+microwave reactor with the “High” absorbance setting. After complete reaction, the vial was cooled to <40° C., homogenised using a vortex mixer, and de-capped. The finished reaction mixture sampled for HNMR and GPC.

¹H NMR measurement showed 87% consumption of the ADAMS monomer and 81% consumption of the acrylate co-monomer. GPC measurement showed a polymer with Mn=9214 g/mol and polydispersity index (PDI)=1.81.

### Example 2

To a 2-5 mL microwave reaction vial, containing a magnetic stir bar, was charged 12.5 mg azobisisobutyronitrile (AIBN, 0.076 mmol, 0.01 eq.), 2.00 g N,N-bis(2-methoxyethyl)-3-phenylbut-3-en-1-amine (7.59 mmol, 1.0 eq.), 1.40 g 2-ethylhexyl acrylate (7.59 mmol, 1.0 eq.), and ˜100 μL benzyl benzoate (internal HNMR standard).

The reaction vial was then capped and the reaction mixture homogenised using a vortex mixer. A ˜50 μL aliquot of the starting reaction mixture was taken for ¹H NMR analysis using a needle+syringe inserted through the septum on the vial cap. The reaction mixture and vial headspace were then degassed with N2 for 15 minutes.

The reaction vial was then mixture heated to 90° C. for 5 hours, using the using a BIOTAGE INITIATOR+microwave reactor with the “High” absorbance setting. After complete reaction, the vial was cooled to <40° C., homogenised using a vortex mixer, and de-capped. The finished reaction mixture sampled for HNMR and GPC. ¹H NMR measurement showed 22% consumption of the ADAMS monomer and 61% consumption of the acrylate co-monomer. GPC measurement showed a polymer with Mn=12599 g/mol and polydispersity index (PDI)=1.92.

All documents described herein are incorporated by reference herein, including any priority documents and/or testing procedures, to the extent they are not inconsistent with this text. As should be apparent from the foregoing general description and the specific embodiments, while forms of the invention have been illustrated and described, various modifications can be made without departing from the spirit and scope of the invention. Accordingly, it is not intended that the invention be limited thereby. The term “comprising” specifies the presence of stated features, steps, integers, or components, but does not preclude the presence or addition of one or more other features, steps, integers, components, or groups thereof. As such, the term “comprising” is considered essentially synonymous with the term “including.” Similarly, whenever a composition, an element, or a group of elements is preceded with the transitional phrase “comprising,” it should be understood that the same composition or group of elements is contemplated with transitional phrases “consisting essentially of,” “consisting of,” “selected from the group of consisting of,” or “can be”, “may be”, “is” preceding the recitation of the composition, element, or elements, and vice versa.

In juxtaposition to the well-known terms “comprising” meaning “including what follows and anything else” [open] and “consisting of” meaning “including only what follows” [closed], the term “consisting essentially of” should be understood to be semi-inclusive and to mean, in accordance with US judicial interpretation, including that which follows and other things that do not materially affect the basic and novel properties.

Applicants have attempted to disclose all embodiments and applications of the disclosed subject matter that could be reasonably foreseen. However, there may be unforeseeable, insubstantial modifications that remain as equivalents. While the present invention has been described in conjunction with specific, exemplary embodiments thereof, it is evident that many alterations, modifications, and variations will be apparent to those skilled in the art in light of the foregoing description without departing from the spirit or scope of the present disclosure. Accordingly, the present disclosure is intended to embrace all such alterations, modifications, and variations of the above detailed description.

All patents, test procedures, and other documents cited herein, including priority documents, are fully incorporated by reference to the extent such disclosure is not inconsistent with this invention and for all jurisdictions in which such incorporation is permitted.

When numerical lower limits and numerical upper limits are listed herein, ranges from any lower limit to any upper limit are contemplated.

What is claimed is:

1. A copolymer comprising:
(a) one or more amine-derivatized alpha-methyl styrene (ADAMS) repeat units according to structure (I): 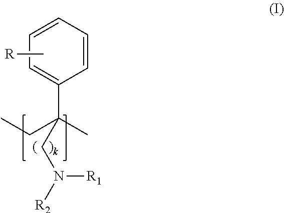
wherein:
k is an integer from 1 to 3;
R₁ and R₂ are each independently a hydrocarbyl group or a hydrocarbonaceous group having 1 to 4 additional heteroatoms selected from the group consisting of O, N, S, P, Se, and combinations thereof, or wherein R₁ and R₂ are connected to form a moiety containing at least one 5-to 12-membered ring, from 3 to 28 carbons, and optionally 1 to 6 additional heteroatoms selected from the group consisting of O, N, S, P, Se, and combinations thereof;
R is hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group, a C₁-C₆ hydrocarbyl group containing 1 to 4 additional heteroatoms selected from the group consisting of O, N, S, P, Se, and combinations thereof;
(b) one or more repeat units selected from the group of structures (II): 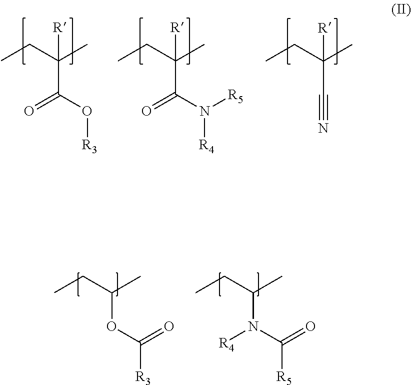
and combinations thereof, wherein:
R′ is a hydrogen or methyl group;
R₃, R₄, and R₅ are each independently a hydrogen atom, a hydrocarbyl group having 1 to 30 carbon atoms, or a hydrocarbonaceous group having 1 to 30 carbon atoms and 1 to 6 additional heteroatoms selected from the group consisting of O, N, S, P, Si, and combinations thereof, or
wherein R₃ is a hydrocarbyl or hydrocarbonaceous polymer having number-average molecular weight below 10,000 Da and optionally additional heteroatoms selected from the group of O, N, S, P, Se, or a combination thereof, or
wherein R₄ and R₅ are connected to form a moiety containing at least one 5-to 12-membered ring, from 3 to 30 carbon atoms, and optionally 1 to 6 additional heteroatoms selected from the group consisting of O, N, S, P, Si, or a combination thereof.

2. The copolymer of claim 1, wherein k=2.

3. The copolymer of claim 1, wherein the one or more ADAMS repeat units according to structure (I) comprise the reacted form of 1-dimethylamino-3-phenylbut-3-ene, 1-diethylamino-3-phenylbut-3-ene, 1-di-n-propylamino-3-phenylbut-3-ene, 1-diisopropylamino-3-phenylbut-3-ene, 1-di-2-propenylamino-3-phenylbut-3-ene, 1-di-n-butylamino-3-phenylbut-3-ene, 1-di-sec-butylamino-3-phenylbut-3-ene, 1-diisobutylamino-3-phenylbut-3-ene, 1-di-tert-butylamino-3-phenylbut-3-ene, 1-cyclohexylmethylamino-3-phenylbut-3-ene, 1-dicyclohexylamino-3-phenylbut-3-ene, 1-di-(2-ethylhexyl)amino-3-phenylbut-3-ene, 1-di-(methoxyethyl)amino-3-phenylbut-3-ene, 1-di-(ethoxyethyl)amino-3-phenylbut-3-ene, 1-di-(phenoxyethyl)amino-3-phenylbut-3-ene, 1-di-(methylthioethyl)amino-3-phenylbut-3-ene, 1-di-(ethylthioethyl)amino-3-phenylbut-3-ene, 1-benzylmethylamino-3-phenylbut-3-ene, 1-dibenzylamino-3-phenylbut-3-ene, 1-benzylphenylamino-3-phenylbut-3-ene, 1-diphenylamino-3-phenylbut-3-ene, 1-dipyridylamino-3-phenylbut-3-ene, 1-phenylmethylamino-3-phenylbut-3-ene, 1-phenylmethoxyethylamino-3-phenylbut-3-ene, 1-benzylmethoxyethylamino-3-phenylbut-3-ene, 1-(N-morpholinyl)-3-phenylbut-3-ene, 1-(N-thiomorpholinyl)-3-phenylbut-3-ene, 1-(N-piperidinyl)-3-phenylbut-3-ene, 1-(N-piperazinyl)-3-phenylbut-3-ene, 1-(N-diazepanyl)-3-phenylbut-3-ene, 1-(N-pyrrolidinyl)-3-phenylbut-3-ene, 1-(N-pyrrolyl)-3-phenylbut-3-ene, 1-(1,2,3,4-tetrahydro-1-quinolinyl)-3-phenylbut-3-ene, 1-(1,2,3,4-tetrahydro-2-isoquinolinyl)-3-phenylbut-3-ene, 1-(N-indolinyl)-3-phenylbut-3-ene, 1-(N-indolyl)-3-phenylbut-3-ene, 1-(N-carbazolyl)-3-phenylbut-3-ene, 1-(N-phenothiazinyl)-3-phenylbut-3-ene, 1-(N-phenothiazinyl-S-oxide)-3-phenylbut-3-ene, 1-(N-phenothiazinyl-S,S-dioxide)-3-phenylbut-3-ene, 1-(N-phenoxazinyl)-3-phenylbut-3-ene, 1-(4-methyl-1-piperazinyl)-3-phenylbut-3-ene, 1-(5-methyl-2,5-diazabicyclo[2.2.1]heptan-2-yl)-3-phenylbut-3-ene, 1-(5-methyl-2,5-diazabicyclo[2.2.2]octan-2-yl)-3-phenylbut-3-ene, 1-(4-cyclopentyl-1-piperazinyl)-3-phenylbut-3-ene, 1-(4-cyclopentadienyl-1-piperazinyl)-3-phenylbut-3-ene, 1-(4-phenyl-1-piperazinyl)-3-phenylbut-3-ene, 1-(4-(thiazolyl)-1-piperazinyl)-3-phenylbut-3-ene, 1-(4-(thiadiazolyl)-1-piperazinyl)-3-phenylbut-3-ene, 1-(4-(triazolyl)-1-piperazinyl)-3-phenylbut-3-ene, 1-(4-(1,2,3-benzotriazolyl)-1-piperazinyl)-3-phenylbut-3-ene, 1-(N′-methyl-N-diazepanyl)-3-phenylbut-3-ene, N,N′-bis(3-phenylbut-3-enyl)diazepane, N,N′-bis(3-phenylbut-3-enyl)piperazine, N,N′-bis(3-phenylbut-3-enyl)dihydrophenazine, N,N′-bis(3-phenylbut-3-enyl)dihydrobenzoindazole, N,N′-bis(3-phenylbut-3-enyl)dihydropermidine, N,N′-bis(3-phenylbut-3-enyl)octahydropyridoquinoline, N,N′-bis(3-phenylbut-3-enyl)octahydropyridoisoquinoline, N,N′-bis(3-phenylbut-3-enyl)hexahydropyrroloquinoline, N,N′-bis(3-phenylbut-3-enyl) hexahydropyrroloisoindole, N,N′-bis(3-phenylbut-3-enyl)hexahydropyrroloisoquinoline, N,N′-bis(3-phenylbut-3-enyl)diazabicyclo[2.2.2]octane, N,N′-bis(3-phenylbut-3-enyl)diazabicyclo[2.2.1]heptane, 1,3-bis(1-(3-phenylbut-3-enyl)piperidin-4-yl) propane, bis(1-dimethylamino-3-phenylbut-3-enyl)benzene, bis(1-benzylmethylamino-3-phenylbut-3-enyl)benzene, bis(1-(N-morpholinyl)-3-phenylbut-3-enyl)benzene, bis(1-(N-thiomorpholinyl)-3-phenylbut-3-enyl)benzene, bis(1-(di-methoxyethyl)amino-3-phenylbut-3-enyl)benzene, bis(1-(N-piperidinyl)-3-phenylbut-3-enyl)benzene, bis(1-(N-pyrrolidinyl)-3-phenylbut-3-enyl)benzene, bis(1-(4-methyl-1-piperazinyl))-3-phenylbut-3-enyl) benzene, or a combination thereof.

4. The copolymer of claim 1, wherein the one or more repeat units selected from the group of structures (II) comprise the reacted form of acrylates, methacrylates, acrylamides, methacrylamides, acrylonitriles, methacrylonitriles, vinyl ethers, N-vinyl amides, and combinations thereof.

5. The copolymer of claim 1, further comprising one or more additional repeat units comprising the reacted form of styrene, alpha-methylstyrene, para-methylstyrene, 2-vinylpyridine, 3-vinylpyridine, 4-vinylpyridine, or a combination thereof.

6. The copolymer of claims 1, further comprising one or more additional repeat units according to structure (III): 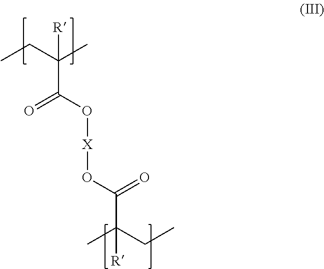
wherein:
R′ is a hydrogen or methyl;
X is a hydrocarbyl group or a hydrocarbonaceous group having 1 to 20 additional heteroatoms selected from the group consisting of O, N, S, P, Se, and combinations thereof, or wherein X is a hydrocarbyl or hydrocarbonaceous polymer having number-average molecular weight below 10,000 Da and optionally additional heteroatoms selected from the group of O, N, S, P, Se, or a combination thereof.

7. The copolymer of claim 1, wherein an amino group in one or more repeat units of structure (I) are protonated or alkylated to their corresponding ammonium salt.

8. The copolymer of claim 7, wherein the protonated or alkylated ammonium salt comprises a chloride, bromide, iodide, alkyl or aryl sulfonate, sulfate, phosphate, formate, acetate, propionate, butyrate, benzoate, triflate, nitrate counterion, or a combination thereof.

9. A copolymer comprising the reaction product of:
(a) one or more monomers according to structure (I) 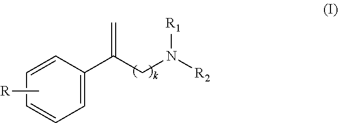
wherein:
k is an integer from 1 to 3;
R₁ and R₂ are each independently a hydrocarbyl group or a hydrocarbonaceous group having 1 to 4 additional heteroatoms selected from the group consisting of O, N, S, P, Se, and combinations thereof, or wherein R₁ and R₂ are connected to form a moiety containing at least one 5-to 12-membered ring, from 3 to 28 carbons, and optionally 1 to 6 additional heteroatoms selected from the group consisting of O, N, S, P, Se, and combinations thereof;
R is hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group, a C₁-C₆ hydrocarbyl group containing 1 to 4 additional heteroatoms selected from the group consisting of O, N, S, P, Se, and combinations thereof;
(b) one or more comonomers selected from the group consisting of optionally substituted acrylates, methacrylates, acrylamides, methacrylamides, acrylonitriles, methacrylonitriles, vinyl ethers, N-vinyl amides, or combinations thereof.

10. The copolymer of claim 9, wherein the one or more monomers according to structure (I) comprise 1-dimethylamino-3-phenylbut-3-ene, 1-diethylamino-3-phenylbut-3-ene, 1-di-n-propylamino-3-phenylbut-3-ene, 1-diisopropylamino-3-phenylbut-3-ene, 1-di-2-propenylamino-3-phenylbut-3-ene, 1-di-n-butylamino-3-phenylbut-3-ene, 1-di-sec-butylamino-3-phenylbut-3-ene, 1-diisobutylamino-3-phenylbut-3-ene, 1-di-tert-butylamino-3-phenylbut-3-ene, 1-cyclohexylmethylamino-3-phenylbut-3-ene, 1-dicyclohexylamino-3-phenylbut-3-ene, 1-di-(2-ethylhexyl)amino-3-phenylbut-3-ene, 1-di-(methoxyethyl)amino-3-phenylbut-3-ene, 1-di-(ethoxyethyl)amino-3-phenylbut-3-ene, 1-di-(phenoxyethyl)amino-3-phenylbut-3-ene, 1-di-(methylthioethyl)amino-3-phenylbut-3-ene, 1-di-(ethylthioethyl)amino-3-phenylbut-3-ene, 1-benzylmethylamino-3-phenylbut-3-ene, 1-dibenzylamino-3-phenylbut-3-ene, 1-benzylphenylamino-3-phenylbut-3-ene, 1-diphenylamino-3-phenylbut-3-ene, 1-dipyridylamino-3-phenylbut-3-ene, 1-phenylmethylamino-3-phenylbut-3-ene, 1-phenylmethoxyethylamino-3-phenylbut-3-ene, 1-benzylmethoxyethylamino-3-phenylbut-3-ene, 1-(N-morpholinyl)-3-phenylbut-3-ene, 1-(N-thiomorpholinyl)-3-phenylbut-3-ene, 1-(N-piperidinyl)-3-phenylbut-3-ene, 1-(N-piperazinyl)-3-phenylbut-3-ene, 1-(N-diazepanyl)-3-phenylbut-3-ene, 1-(N-pyrrolidinyl)-3-phenylbut-3-ene, 1-(N-pyrrolyl)-3-phenylbut-3-ene, 1-(1,2,3,4-tetrahydro-1-quinolinyl)-3-phenylbut-3-ene, 1-(1,2,3,4-tetrahydro-2-isoquinolinyl)-3-phenylbut-3-ene, 1-(N-indolinyl)-3-phenylbut-3-ene, 1-(N-indolyl)-3-phenylbut-3-ene, 1-(N-carbazolyl)-3-phenylbut-3-ene, 1-(N-phenothiazinyl)-3-phenylbut-3-ene, 1-(N-phenothiazinyl-S-oxide)-3-phenylbut-3-ene, 1-(N-phenothiazinyl-S,S-dioxide)-3-phenylbut-3-ene, 1-(N-phenoxazinyl)-3-phenylbut-3-ene, 1-(4-methyl-1-piperazinyl)-3-phenylbut-3-ene, 1-(5-methyl-2,5-diazabicyclo[2.2.1]heptan-2-yl)-3-phenylbut-3-ene, 1-(5-methyl-2,5-diazabicyclo[2.2.2]octan-2-yl)-3-phenylbut-3-ene, 1-(4-cyclopentyl-1-piperazinyl)-3-phenylbut-3-ene, 1-(4-cyclopentadienyl-1-piperazinyl)-3-phenylbut-3-ene, 1-(4-phenyl-1-piperazinyl)-3-phenylbut-3-ene, 1-(4-(thiazolyl)-1-piperazinyl)-3-phenylbut-3-ene, 1-(4-(thiadiazolyl)-1-piperazinyl)-3-phenylbut-3-ene, 1-(4-(triazolyl)-1-piperazinyl)-3-phenylbut-3-ene, 1-(4-(1,2,3-benzotriazolyl)-1-piperazinyl)-3-phenylbut-3-ene, 1-(N′-methyl-N-diazepanyl)-3-phenylbut-3-ene, N,N′-bis(3-phenylbut-3-enyl)diazepane, N,N′-bis(3-phenylbut-3-enyl)piperazine, N,N′-bis(3-phenylbut-3-enyl)dihydrophenazine, N,N′-bis(3-phenylbut-3-enyl)dihydrobenzoindazole, N,N′-bis(3-phenylbut-3-enyl)dihydropermidine, N,N′-bis(3-phenylbut-3-enyl)octahydropyridoquinoline, N,N′-bis(3-phenylbut-3-enyl)octahydropyridoisoquinoline, N,N′-bis(3-phenylbut-3-enyl)hexahydropyrroloquinoline, N,N′-bis(3-phenylbut-3-enyl)hexahydropyrroloisoquinoline, N,N′-bis(3-phenylbut-3-enyl)hexahydropyrroloisoindole, N,N′-bis(3-phenylbut-3-enyl)diazabicyclo[2.2.1]heptane, N,N′-bis(3-phenylbut-3-enyl)diazabicyclo[2.2.2]octane, 1,3-bis(1-(3-phenylbut-3-enyl)piperidin-4-yl)propane, bis(1-dimethylamino-3-phenylbut-3-enyl)benzene, bis(1-benzylmethylamino-3-phenylbut-3-enyl)benzene, bis(1-(N-morpholinyl)-3-phenylbut-3-enyl)benzene, bis(1-(N-thiomorpholinyl)-3-phenylbut-3-enyl)benzene, bis(1-(di-methoxyethyl) amino-3-phenylbut-3-enyl)benzene, bis(1-(N-piperidinyl)-3-phenylbut-3-enyl)benzene, bis(1-(N-pyrrolidinyl)-3-phenylbut-3-enyl)benzene, bis(1-(4-methyl-1-piperazinyl))-3-phenylbut-3-enyl)benzene, or a combination thereof.

11. A method of making a copolymer according to claim 9 via radical solution polymerization comprising the steps of:
(a) combining the one or more monomers and the one or more comonomers, with or without one or more solvents, under an inert gas atmosphere to form a mixture of monomers and comonomers;
(b) optionally adding one or more reaction modifiers comprising chain transfer agents or reversible addition fragmentation chain transfer agents to the mixture of monomers and comonomers;
(c) adding one or more radical initiators to the mixture of step (b) to form a mixture of monomers, comonomers, radical initiators and optional reaction modifiers; and
(d) heating or cooling the mixture of monomers, comonomers, radical initiators and optional reaction modifiers at a sufficient temperature and for a sufficient time to initiate and propagate radical polymerization to form a copolymer.

12. A method of using a copolymer comprising:
providing the copolymer according to claim 1, or an additive mixture including the copolymer according to claim 1, and
using the copolymer or the additive mixture including the copolymer in an application selected from the group consisting of an adhesive additive, a lithium-ion battery additive, a plastic additive, a drag reducing agent, a magneto-rheological fluid, an electro-chlorination additive, an industrial coating additive, an asphaltene and wax inhibitor, a refinery anti-foulant, an industrial or household surfactant, an agrochemical additive, a ceramic capacitor or inductor additive, an emulsion explosive additive, an anti-microbial coating, a crude transportation and refining additive, a carbon-capture additive, or a construction material additive.
